(19) United States
(12) Patent Application Publication
(10) Pub. No.: US 2018/0348394 A1
(43) Pub. Date: Dec. 6, 2018

(54) MODULAR TOOL HAVING COMBINED EM LOGGING AND TELEMETRY

(71) Applicant: Halliburton Energy Services, Inc., Houston, TX (US)

(72) Inventors: Glenn Andrew Wilson, Houston, TX (US); Burkay Donderici, Houston, TX (US)

(73) Assignee: Halliburton Energy Services, Inc., Houston, TX (US)

(21) Appl. No.: 15/771,716

(22) PCT Filed: Dec. 7, 2015
(86) PCT No.: PCT/US2015/064249

§ 371 Date: Apr. 27, 2018

(51) Int. Cl. G01V 3/28

(52) U.S. Cl. CPC G01V 3/28

(57) ABSTRACT

An electromagnetic logging tool module includes: a transmitter that sends an electromagnetic transmit signal; a receiver that derives a receive signal from a formation response to a remote module's electromagnetic signal; a processor that processes the receive signal to obtain a measurement of the formation response, wherein the processor demodulates the receive signal to determine the remote module's measurement of a formation response to the electromagnetic transmit signal, and wherein the processor further modulates the electromagnetic transmits signal to share the obtained measurement with the remote module. The module may be part of a tool that includes a plurality of such electromagnetic logging tool modules each: deriving a receive signal from a formation in response to a modulated electromagnetic signal from another module in said plurality; processing the receive signal to obtain a local formation response measurement; demodulating the receive signal to determine a remote formation response measurement; and sending an electromagnetic transmit signal that is modulated with the local formation response measurement.

### BACKGROUND

Petroleum drilling and production operations demand a great quantity of information relating to the parameters and conditions downhole. Such information typically includes the location and orientation of the wellbore and drilling assembly, earth formation properties, and drilling environment parameters downhole. The collection of information relating to formation properties and conditions downhole is commonly referred to as “logging” or “formation evaluation”, and can be performed during the drilling process itself (“logging-while-drilling”) or afterwards (“wireline logging”).

Electromagnetic (“EM”) logging tools are used in both wireline logging and logging while drilling contexts to measure EM properties of the formation such as resistivity. EM logging tools commonly include one or more antennas for transmitting an electromagnetic signal into the formation and one or more antennas for receiving a formation response. The amplitude and phase of the received signals can be used to measure formation resistivity at a distance that depends on frequency of the signals and separation between the antennas. This distances increases as the separation increases. It is infeasible for a unitary tool to provide a separation greater than about ten meters, necessitating the use of a non-unitary tool for larger separations. However, the communication requirements of such tools create other difficulties, particularly when one or more intervening units are included between the different parts of the tool.

### BRIEF DESCRIPTION OF THE DRAWINGS

Accordingly, there are disclosed herein modular electromagnetic (“EM”) logging tools that perform simultaneous EM logging and data communications. In the accompanying drawing sheets:

FIG. 1 is a side view of a logging-while-drilling (“LWD”) environment.

FIG. 2 is a function block diagram of an illustrative modular LWD system.

FIG. 3 is a function block diagram of an illustrative EM logging tool module.

FIG. 4 is a side view of an illustrative EM logging tool module.

FIGS. 5A-5B are side views of illustrative EM logging tool string embodiments.

FIG. 6 is a flow diagram of an illustrative EM logging method.

It should be understood, however, that the specific embodiments given in the drawings and detail description do not limit the disclosure. On the contrary, these specific embodiments provide the foundation for one of ordinary skill to discern the alternative forms, equivalents, and modifications, which are encompassed together with one or more of the given embodiments in the scope of the appended claims.

### NOTATION AND NOMENCLATURE

Certain terms are used throughout the following description and claims to refer to particular system components and configurations. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical connection. Thus, if a first device couples to a second device, that connection may be through a direct electrical connection, or through an indirect electrical connection via other devices and connections. In addition, the term “attached” is intended to mean either an indirect or a direct physical connection. Thus, if a first device attaches to a second device, that connection may be through a direct physical connection, or through an indirect physical connection via other devices and connections.

### DETAILED DESCRIPTION

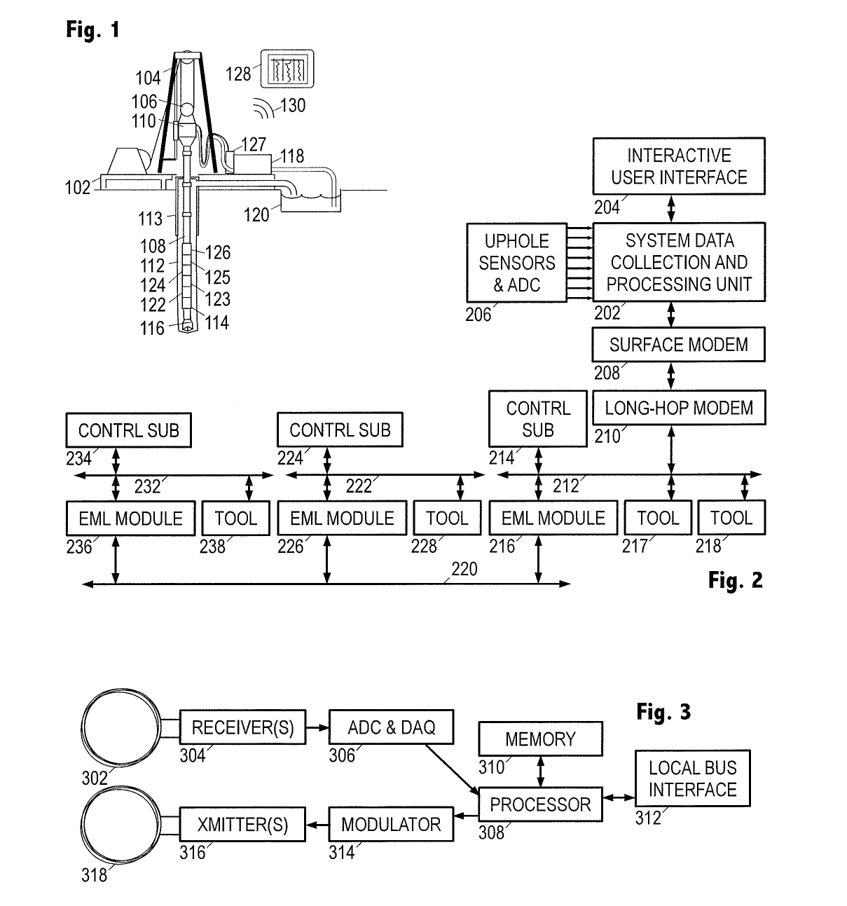

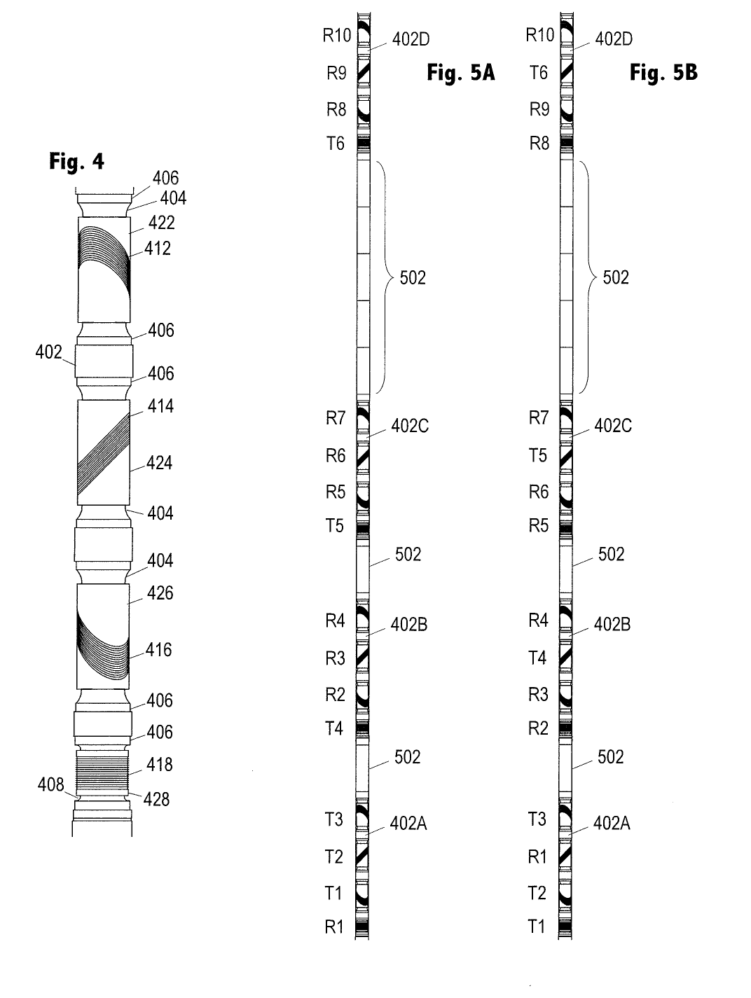

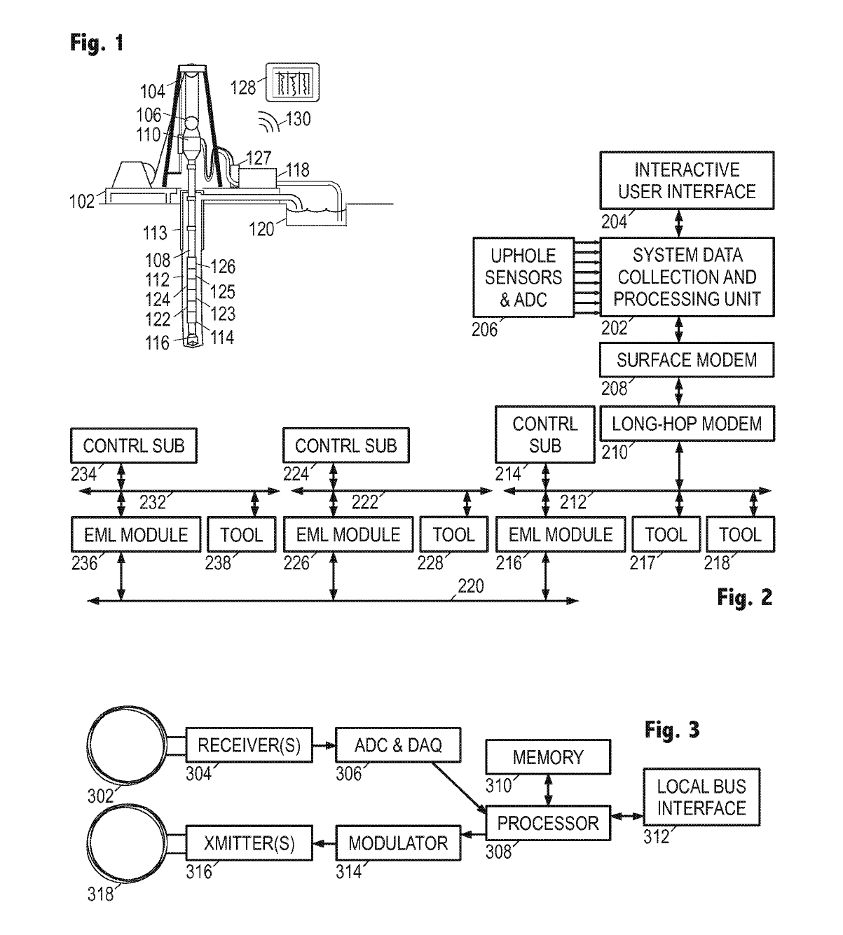

To provide context and facilitate understanding of the present disclosure, FIG. 1 shows an illustrative drilling environment, in which a drilling platform 102 supports a derrick 104 having a traveling block 106 for raising and lowering a drill string 108. A top-drive motor 110 supports and turns the drill string 108 as it is lowered into the borehole 112. The drill string's rotation, alone or in combination with the operation of a downhole motor 114, drives the drill bit 116 to extend the borehole. The drill bit 116 is one component of a bottomhole assembly (BHA) 116 that may further include a steering assembly, drill collars, and logging instruments. A pump 118 circulates drilling fluid through a feed pipe to the top drive 110, downhole through the interior of drill string 8, through orifices in the drill bit 116, back to the surface via the annulus around the drill string 108, and into a retention pit 120. The drilling fluid transports cuttings from the borehole 112 into the retention pit 120 and aids in maintaining the integrity of the borehole. An upper portion of the borehole 112 is stabilized with a casing string 113 and the lower portion being drilled is open (uncased) borehole.

The drill collars 122-126 in the BHA are typically thick-walled steel pipe sections that provide weight and rigidity for the drilling process. The thick walls are also convenient sites for installing logging instruments that measure downhole conditions, various drilling parameters, and characteristics of the formations penetrated by the borehole. Among the typically monitored drilling parameters are measurements of weight, vibration (acceleration), torque, and bending moments at the bit and at other selected locations along the BHA. The BHA typically further includes a navigation tool having instruments for measuring tool orientation (e.g., multi-component magnetometers and accelerometers) and a telemetry transmitter and receiver for communicating information between the BHA and an instrumentation interface 127. A corresponding telemetry to receiver and transmitter is located on or near the drilling platform 102 to complete the telemetry link. The most popular telemetry link is based on modulating the flow of drilling fluid to create pressure pulses that propagate along the drill string (“mud-pulse telemetry or MPT”), but other known telemetry techniques (e.g., EM or acoustic) are suitable.

A surface interface 127 serves as a hub for communicating via the telemetry link and for communicating with the various sensors and control mechanisms on the platform 102. A data processing unit (shown in FIG. 1 as a tablet computer 128) communicates with the surface interface 127 via a wired or wireless link 130, collecting and processing measurement data to generate logs and other visual representations of the acquired data and the derived models to facilitate analysis by a user. The data processing unit may take many suitable forms, including one or more of: an embedded processor, a desktop computer, a laptop computer, a central processing facility, and a virtual computer in the cloud. In each case, software on a non-transitory information storage medium may configure the processing unit to carry out the desired processing, modeling, and display generation.

The disclosed EM logging tools include multiple EM logging tool modules, which may each be embodied as a drill collar in the BHA. Thus, for example, drill collars 122, 124, and 126 may be EM logging tool modules, with intervening drill collars 123 and 125 being other logging tools (e.g., density, sonic, gamma ray, navigational sensors) or simply “dumb iron” (steel tubing without electronics or wiring). At least some embodiments of the EM logging tool modules are designed to be incorporated into the BHA in any order and spacing arrangement while still being able to communicate and operate cooperatively as set forth below.

The EM logging tool system can be represented as functional blocks as shown in FIG. 2. The instrumentation interface 127, alone or in combination with the data processing unit 128, operates as a system data collection and processing unit 202 coupled to a user interface 204 that the user can employ to view visual representations of the data and to control the manner in which the data processing is performed. The data collection and processing unit 202 is further coupled to acquire digitized measurements from a set of uphole sensors 206 (measuring such things as hook load, torque, and other drilling parameters) and a digital telemetry stream from surface model 208. The telemetry stream arrives over a telemetry channel from a “long-hop” modem 210 in the BHA. Modem 210 may employ mud pulse telemetry or any other suitable telemetry technique.

A tool bus 212 provides communications between the long-hop modem 210 and other tools in the BHA. A control sub 214 coordinates communications across the bus 212 and serves as a central storage unit with memory for storing logging data from the various tools until the BHA returns to the surface and the data can be downloaded. The control sub 214 may further track the tool orientation and position to be associated with the tool measurements collected at that orientation and position. The control sub may also perform preliminary processing on the data to enhance signal to noise ratio (SNR), reduce resolution, or otherwise compress the data to reduce telemetry requirements. The control sub 214 may still further generate the telemetry stream by multiplexing selected measurements and data from various sources including EM logging tool module 216 and other tools 217, 218.

EM logging tool module 216 operates in cooperation with other EM logging tool (“EML”) modules 226, 236, to measure electromagnetic characteristics of the formation such as resistivity, bed boundary distance, and bed boundary direction. The EM signals used to measure these characteristics can also be used to convey short-hop telemetry data, e.g., as amplitude and/or phase modulations. Short-hop bus 220 represents this telemetry channel.

In addition to sending EM signals and data for measuring formation characteristics, each of the other EM logging tool modules 226, 236 may further couple to a local tool bus 222, 232 with a control sub 224, 234 that coordinates communications and serves as a storage unit for storing logging data until the BHA returns to the surface and the data can be downloaded. Each local tool bus 222, 232 may further support communications between the control subs, the EM logging tool modules, and one or more additional tools 228, 238. The short-hop bus 220 may further serve as a bridge between the local buses 212, 222, 232, enabling communication between tools on the different local buses. Thus the long-hop telemetry stream may include measurements from each of the tools.

FIG. 3 shows the function blocks of an illustrative EM logging tool module embodiment. One or more coil antennas 302 are each coupled to a receiver 304. The receivers 304 filter and amplify the signals induced in the coil antennas 302. A converter and data acquisition unit 306 digitizes and buffers digital samples of the receive signal. A processor 308 captures and stores the digitized receive signals in memory 310. The processor 308 may further window and filter the receive signals to select those portions of the signal that are sensitive to the measured formation characteristics to derive measurements of those characteristics, optionally combining the resulting measurements with previous measurements to improve signal to noise ratio.

The processor 308 may still further demodulate those portions of the digitized receive signal that represent short-hop telemetry data. The processor 308 directs to the local bus interface 312 those portions of the short-hop telemetry stream that the processor determines are directed to the control sub or one of the other tools on the local tool bus. Those portions of the short-hop telemetry stream that represent remotely-acquired EM logging measurements are directed to memory 310 and optionally to the local bus interface 312 for storage in the control sub. Those portions of the short-hop telemetry stream that are relevant to operation of the EM logging tool module are used by the processor 308, e.g., to determine clock offsets between the EM logging tool modules, to set time windows for sending transmit signals and/or capturing receive signals, and to set signal frequencies and modulation parameters.

The processor 308 takes locally acquired measurements of formation characteristics, along with any short-hop telemetry data received from local bus interface 312, and multiplexes the information into a short-hop telemetry stream. The processor 308 supplies this telemetry stream to modulator 314. At least one of the coil antennas 318 is coupled to a transmitter 316 to send a transmit signal into the formation. Modulator 314 modulates the short-hop telemetry data onto the transmit signal.

A preferred short-hop telemetry modulation strategy employs binary phase shift keying (BPSK). However, M-ary phase-shift keying (M-ary PSK) and other modulation strategies are also contemplated, including pulse width modulation (PWM), pulse position modulation (PPM), on-off keying (OOK), amplitude modulation (AM), frequency modulation (FM), single-sideband modulation (SSM), frequency shift keying (FSK), and discrete multi-tone (DMT) modulation. In those embodiments employing simple waveforms for measuring formation characteristics, the telemetry data may be contemporaneously transmitted using frequency division multiplexing (FDM). Time division multiplexing (TDM) or code-division multiplexing (CDM) may also be employed with only a moderate increase in transmitter and receiver complexity. Even when CDM is not employed, the telemetry data stream may be formatted or coded to introduce signal correlations that facilitate the measurement of formation characteristics.

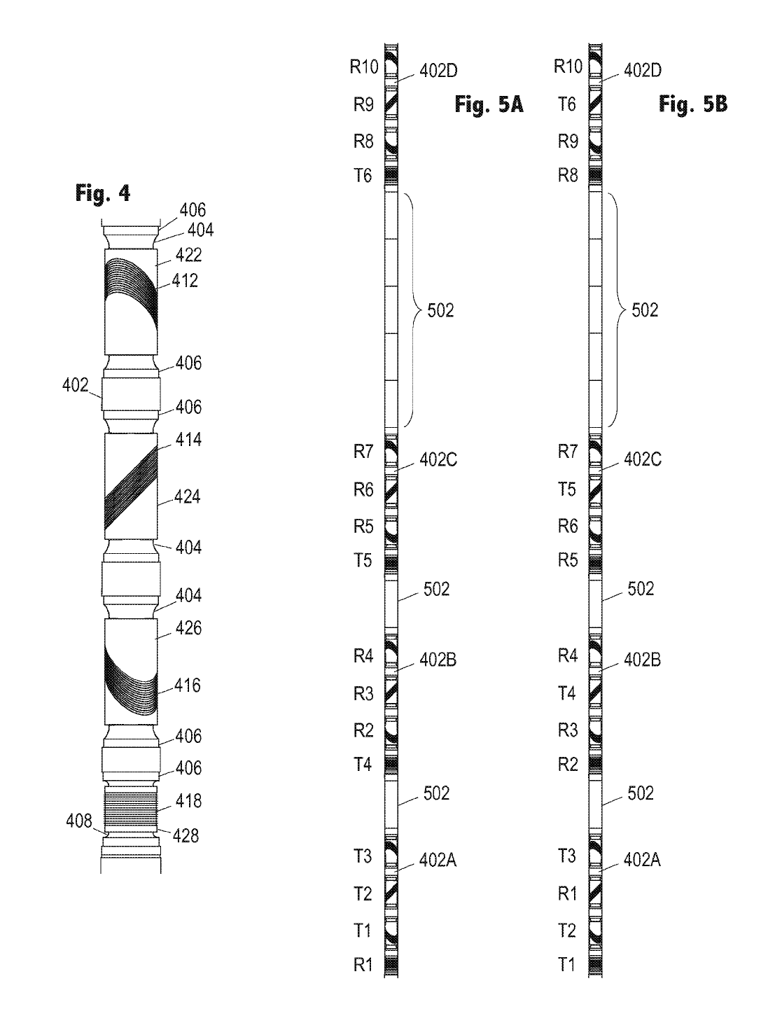

FIG. 4 shows an illustrative EM logging tool module 402 with sleeves removed for explanatory purposes. Module 402 is a drill collar with annular regions 404 of reduced diameter for an arrangement of coil antennas. Each recess includes shoulders 406 to support a protective sleeve for covering and protecting the coil antennas 412, 414, 416, and 418 from damage. The sleeves are at least partially non-conductive to enable EM signals to pass to and from each coil antenna. An antenna support 422 secures coil antenna 412 in a first recess 404 of the module 402. Similarly, supports 424, 426, and 428 secure coil antennas 414, 416, and 418 in respective recesses of module 402.

The supports are a non-conductive material that spaces the coil windings away from the conductive surface of the module 402. In at least some embodiments, the supports consist of a filler material such as epoxy, rubber, ferrite, ceramic, polymer, fiberglass, or other composite material. A material having a high relative magnetic permeability may be preferred to reduce surface currents in the module 402.

Coil antenna 418 is coaxial with module 402, while the triad of coil antennas 412, 414, and 416 are each tilted with respect to the long axis of module 402. The titled coil antennas each have the radiation or sensitivity pattern of a magnetic dipole, with the dipole axis tilted by about 45° relative to the tool axis. As projected onto a plane perpendicular to the long axis of module 402, the three dipole axes are evenly distributed 120° apart. At least one of the coil antennas in each module 402 is employed for sending transmit signals to other modules and at least one of the coil antennas is employed for receiving formation responses to transmit signals from other modules.

Module 402 further houses electronics to implement the function blocks of FIG. 3. In some embodiments, the local tool bus is a one-line communications bus (with the tool body acting as the ground) that enables power transfer and digital communications between modules. The implementation of the tool bus may take the form of a cable that is run through the bore of the tools and manually attached to terminal blocks inside each tool as the BHA is assembled. In some alternative embodiments, the tool bus cable passes through an open or closed channel in the tool wall and is attached to contacts or inductive couplers at each end. As the tools are connected together, these contacts or inductive couplers are placed in electrical communication due to the geometry of the connection.

For example, in a threaded box-and-pin connector arrangement, the box connector may include a conductive male pin held in place on the central axis by one or more supports from the internal wall of the tool. A matching female jack may be similarly held in place on the central axis of the pin connector and positioned to make electrical contact with the male pin when the threaded connection is tight. An O-ring arrangement may be provided to keep the electrical connection dry during drilling operations. In systems requiring an empty bore, the electrical connector may be modified to be an annular connection in which a circularly-symmetric blade abuts a circular socket, again with an O-ring arrangement to keep the electrical connection dry. Other suitable electrical-and-mechanical connectors are known and may be employed.

Each EM logging tool module has an attachment mechanism that enables each module to be coupled to other components of the BHA. In some embodiments, the attachment mechanism is a threaded pin and box mechanism, but other attachment mechanisms are also contemplated to enable the modules to be attached with controlled azimuthal alignments relative to each other (e.g., a union fitting mechanism with an alignment slot and key).

FIG. 5A shows an illustrative EM logging tool string having four EM logging tool modules 402A, 402B, 402C, and 402D with intervening drill collars 502. Drill collars 502 are not drawn to scale, and the protective sleeves have again been omitted for explanatory purposes. Module 402A is positioned closest to the drill bit while module 402D is positioned furthest away. Modules 402B, 402C, and 402D may be respectively spaced about 25, 50, and 100 feet from module 402A (as measured between the coaxial antennas).

In module 402A, the coaxial antenna is coupled to a receiver R1 while the triad of tilted coil antennas are each coupled to transmitters T1, T2, and T3. The remaining modules 402B, 402C, and 402D have a complementary antenna configuration, with the coaxial antennas being coupled to transmitters T4, T5, T6, and the tilted coil antenna triads coupled to receivers R2, R3, and R4; R5, R6, and R7; and R8, R9, and R10. Other complementary configurations are also possible, with module 402A coupling one of the tilted coil antennas to a receiver and the remaining modules coupling one of the tilted coil antennas to a transmitter as shown in FIG. 5B.

In operation, a transmitter coil sends an interrogating electromagnetic signal which propagates out of the borehole and into the surrounding formation. The propagating signal and any induced formation current induce a signal voltage in each of the receiver coils, producing a receive signal that is processed to measure amplitude and phase. The measurements may be absolute or may be made relative to amplitude and phase of other receive signals. The operation is repeated using each receiver antenna to measure a response to each transmitter antenna. As discussed previously, the measurements of each module are preferably modulated onto the transmit signal of the local transmitter antenna to be shared with the other EM logging tool modules. To facilitate sharing and determination of tool orientation, each measurement is time-stamped, e.g., by being associated with a local clock count. The set of signal measurements as a function of tool position and orientation is processed to determine a spatial distribution of resistivity, including distance and direction to boundaries between formation beds having different resistivities.

As described above, each tool module includes a recess around the external circumference of the tubular. An antenna is disposed within the recess in the tubular tool assembly, leaving no radial profile to hinder the placement of the tool string within the borehole. In some alternative embodiments, the antenna may be wound on a non-recessed segment of the tubular if desired, perhaps between protective wear bands.

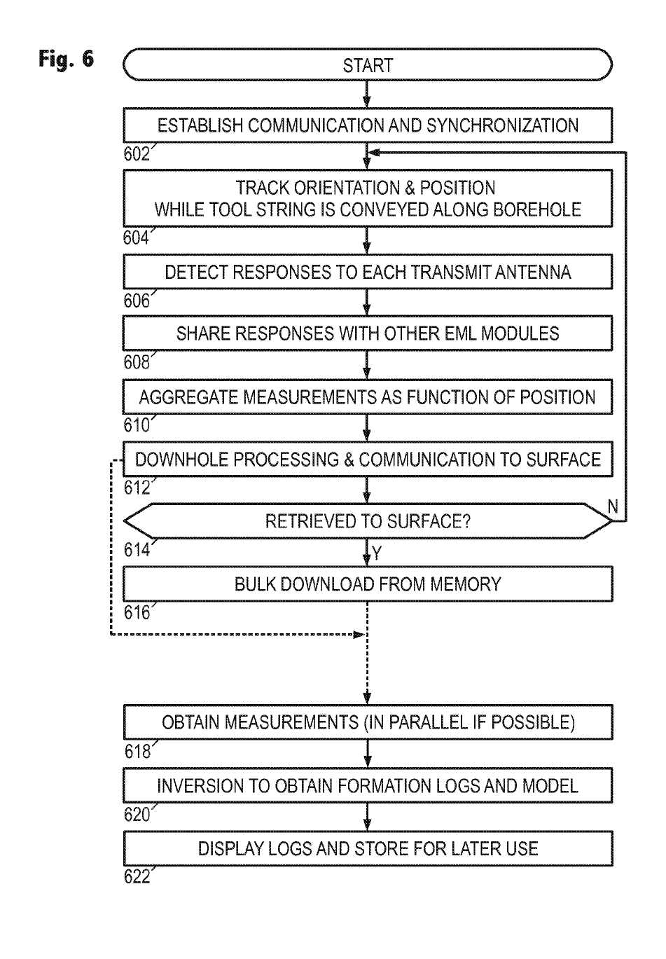

FIG. 6 is a flow diagram of an illustrative EM logging method. Each of the EM logging tool modules may perform each of the blocks 602-616. The method begins in block 602 with the modules establishing communication and performing a synchronization procedure. A wide variety of communication protocols are known in the literature for carrying out these operations and any suitable one can be employed.

For example, one of the modules may be designated as the master and may set a framing protocol that specifies to the other modules the time slots that should be used by each module for sending its transmit signals. When operations are initiated, the master broadcasts a beacon signal and listens for responses. The remaining “slave” modules listen for the beacon and respond with a random delay to minimize collisions. Upon detecting responses from each slave module, the master module institutes a regular framing protocol that provides a designated time slot for each module to sent transmit signals. The first few frames are then used to determine each module's clock offset relative to the master module's clock.

Several approaches to this synchronization operation are also known in the literature and can be used. One contemplated technique includes using a round-trip message to each slave module, with the master module tracking the total round-trip travel time, subtracting any turnaround delay reported by the slave module, and dividing the difference in half to determine the one-way travel time. The one-way travel time is then added to a clock count reported by the slave module before it is compared with master clock count to determine a clock offset for that slave module. Whether performed in this fashion or in another way, the synchronization operation enables each clock offset between the EM logging tool modules to be determined and monitored precisely. Moreover, the master EM logging tool module may share the calculated offsets with each of the slave modules.

In block 604, each of the EM logging tool modules (internally or via an associated navigational package) tracks the tool orientation and position as the tool string is conveyed along the borehole, e.g., as part of a drilling or tripping operation. The tool orientation and position information will be associated with the corresponding tool measurements.

In block 606, each EM logging tool module acquires receive signals representative of the formation response to a transmit signal from another module. A receive signal is acquired for each receive antenna in response to a signal from each remote transmit antenna. The EM logging tool module measures an amplitude and phase of each receive signal, e.g. as in-phase and quadrature components relative to an oscillator signal derived from the local clock signal. The phase may then be corrected to account for a clock offset from the transmitting EM tool module. In at least some embodiments, the transmit signal includes a pulsed sinusoidal waveform having a predetermined carrier frequency and phase. The sinusoidal pulse may be followed by modulations of the carrier frequency to convey telemetry data, or the telemetry data may be frequency multiplexed or code-division multiplexed with the sinusoidal pulse. In any case, the EM logging tool module demodulates the receive signal to obtain the telemetry data, which preferably includes receive signal measurements obtained by other modules.

In block 608, each EM logging tool module sends a transmit signal for other modules to receive and process to determine amplitude and phase measurements indicative of formation characteristics, and to demodulate to obtain and store measurements made by other modules. Each measurement is associated with a tool position and orientation, enabling it to be combined with other measurements to enhance measurement signal to noise ratio in block 610. The measurements are stored as a function of position and orientation to form a log of the measured formation characteristics.

In block 612, one of the EM logging tool modules optionally compresses selected measurements and supplies them to the long-hop modem for communication to the surface while the drilling or tripping operations are ongoing. In block 614, the EM logging tool modules determine if the BHA has reached the surface, indicating that logging operations should be terminated. If not, blocks 604-614 are repeated.

Otherwise, in block 616, the EM logging tool modules make their stored measurement log data available for download. In some embodiments, each of the EM logging tool modules (or affiliated control subs) is equipped with a wired or wireless communications port. In block 618, each of these ports is coupled to a data retrieval unit to communicate the data to the system data collection and processing unit 202. If more than one data retrieval unit is available, the download may be performed in parallel to speed the data acquisition.

In block 620, the processing unit 202 processes the measurements to derive a formation model and obtain refined logs of the desired formation characteristics. In block 622, these logs and models are displayed and/or stored for future use. The azimuthal sensitivity provided by the use of tilted coil antennas enables the measurements to be used for geosteering relative to bed boundaries and relative to preexisting well bores. The existing well bores may be occupied with a steel casing cemented in place, and may be filled with a fluid having a resistivity quite different from the surrounding formations. As the new well bore is drilled, the azimuthally sensitive resistivity tool enables the detection of direction and distance to the existing well bores.

Though the operations represented by the blocks in FIG. 6 are shown occurring in a sequential fashion, in practice many of the various operations are likely to occur in an overlapping, parallel fashion in which the order of operations need not be strictly ordered. Numerous other variations and modifications will become apparent to those skilled in the art once the above disclosure is fully appreciated. For example, it is expected that the disclosed tool construction methods may be employed in wireline tools as well as logging while drilling tools. In logging while drilling, the drill string may be wired or unwired drill pipe or coiled tubing. It is intended that the appended claims cover all such modifications and variations as fall within the true spirit and scope of this present invention.

Among the embodiments disclosed herein are:

A: An electromagnetic logging tool module that comprises: a transmitter that sends an electromagnetic transmit signal; a receiver that derives a receive signal from a formation response to a remote module's electromagnetic signal; a processor that processes the receive signal to obtain a measurement of the formation response, wherein the processor demodulates the receive signal to determine the remote module's measurement of a formation response to the electromagnetic transmit signal, and wherein the processor further modulates the electromagnetic transmits signal to share the obtained measurement with the remote module.

B: A modular electromagnetic logging tool that comprises: a plurality of electromagnetic logging tool modules each having: a receiver that derives a receive signal from a formation in response to a modulated electromagnetic signal from another module in said plurality; a processor that processes the receive signal to obtain a local formation response measurement and that demodulates the receive signal to determine a remote formation response measurement; and a transmitter that sends an electromagnetic transmit signal that is modulated with the local formation response measurement.

C: An electromagnetic logging method that comprises: conveying a first and a second electromagnetic (EM) logging tool module along a borehole; obtaining with the first module a first measurement of a propagation characteristic of a first receive signal in response to a first transmit signal from the second module; demodulating with the first module the first receive signal to get a propagation characteristic measurement obtained by the second module; obtaining with the second module a second measurement of the propagation characteristic of a second receive signal in response to a second transmit signal from the first module; demodulating with the second module the second receive signal to get a propagation characteristic measurement obtained by the first module.

Each of the embodiments A, B, and C, may have one or more of the following additional features in any combination: (1) the remote module's measurement of a formation response and the obtained measurement of the formation response represent electromagnetic signal amplitude or attenuation. (2) the remote module's electromagnetic signal is modulated to include timing information that enables the obtained measurement to represent a phase shift of the formation response. (3) each module include an antenna set that includes a coaxial antenna and a triad of tilted antennas, with one of the antennas in the antenna set being coupled to the transmitter and the remaining antennas being used for deriving receive signals. (4) said one of the antennas is the coaxial antenna. (5) each module includes an antenna set that includes a coaxial antenna and a triad of tilted antennas, with one of the antennas in the antenna set being coupled to the receiver and the remaining antennas being used for sending electromagnetic transmit signals. (6) each module includes a memory. (7) a processor in each module determines and stores in the memory one or more characteristics of the formation based at least in part on the local formation response measurement and the remote formation response measurement. (8) one of the plurality of electromagnetic logging tool modules is coupled to a long-hop telemetry sub to communicate stored formation characteristics to an uphole interface. (9) each of the electromagnetic logging tool modules includes a wireless port that provides a bulk download of stored formation characteristics after the given module is retrieved from a logging run. (10) the stored formation characteristics include formation resistivity, a bed boundary distance, and a bed boundary direction. (11) each electromagnetic logging tool module includes an antenna set that includes a coaxial antenna and a triad of tilted antennas. (12) one of said plurality of electromagnetic logging tool modules has one receive antenna in the antenna set and the remaining electromagnetic logging tools in the plurality have one transmit antenna in the antenna set. (13) said one receive antenna and said one transmit antenna are the coaxial antennas in the set. (14) said one receive antenna and said one transmit antenna are tilted antennas. (15) said one transmit antenna is aligned parallel to said one receive antenna. (16) each of said propagation characteristic measurements comprises amplitude. (17) each of said propagation characteristic measurements comprises phase. (18) at least one of the modules determines a clock offset relative to other modules. (19) a tool orientation and position is associated with each of said propagation characteristic measurements.

What is claimed is:

1. An electromagnetic logging tool module that comprises:
a transmitter that sends an electromagnetic transmit signal;
a receiver that derives a receive signal from a formation response to a remote module's electromagnetic signal;
a processor that processes the receive signal to obtain a measurement of the formation response,
wherein the processor demodulates the receive signal to determine the remote module's measurement of a formation response to the electromagnetic transmit signal, and
wherein the processor further modulates the electromagnetic transmits signal to share the obtained measurement with the remote module.

2. The module of claim 1, wherein the remote module's measurement of a formation response and the obtained measurement of the formation response represent electromagnetic signal amplitude or attenuation.

3. The module of claim 1, wherein the remote module's electromagnetic signal is modulated to include timing information that enables the obtained measurement to represent a phase shift of the formation response.

4. The module of claim 1, further comprising an antenna set that includes a coaxial antenna and a triad of tilted antennas, with one of the antennas in the antenna set being coupled to the transmitter and the remaining antennas being used for deriving receive signals.

5. The module of claim 4, wherein said one of the antennas is the coaxial antenna.

6. The module of claim 1, further comprising an antenna set that includes a coaxial antenna and a triad of tilted antennas, with one of the antennas in the antenna set being coupled to the receiver and the remaining antennas being used for sending electromagnetic transmit signals.

7. The module of claim 6, wherein said one of the antennas is the coaxial antenna.

8. A modular electromagnetic logging tool that comprises:
a plurality of electromagnetic logging tool modules each having:
a receiver that derives a receive signal from a formation in response to a modulated electromagnetic signal from another module in said plurality;
a processor that processes the receive signal to obtain a local formation response measurement and that demodulates the receive signal to determine a remote formation response measurement; and
a transmitter that sends an electromagnetic transmit signal that is modulated with the local formation response measurement.

9. The tool of claim 8, wherein each module in said plurality further includes a memory, and wherein the processor in each module determines and stores in the memory one or more characteristics of the formation based at least in part on the local formation response measurement and the remote formation response measurement.

10. The tool of claim 9, wherein one of the plurality of electromagnetic logging tool modules is coupled to a long-hop telemetry sub to communicate stored formation characteristics to an uphole interface.

11. The tool of claim 10, wherein each of the plurality of electromagnetic logging tool modules includes a wireless port that provides a bulk download of stored formation characteristics after the given module is retrieved from a logging run.

12. The tool of claim 9, wherein the stored formation characteristics include formation resistivity, a bed boundary distance, and a bed boundary direction.

13. The tool of claim 9, wherein each of the plurality of electromagnetic logging tool modules includes an antenna set that includes a coaxial antenna and a triad of tilted antennas.

14. The tool of claim 13, wherein one of said plurality of electromagnetic logging tool modules has one receive antenna in the antenna set and the remaining electromagnetic logging tools in the plurality have one transmit antenna in the antenna set.

15. The tool of claim 14, wherein said one receive antenna and said one transmit antenna are the coaxial antennas in the set.

16. The tool of claim 14, wherein said one receive antenna and said one transmit antenna are tilted antennas.

17. The tool of claim 16, wherein said one transmit antenna is aligned parallel to said one receive antenna.

18. An electromagnetic logging method that comprises:
conveying a first and an second electromagnetic (EM) logging tool module along a borehole;
with the first module:
obtaining a first measurement of a propagation characteristic of a first receive signal in response to a first transmit signal from the second module;
demodulating the first receive signal to get a propagation characteristic measurement obtained by the second module;
with the second module:
obtaining a second measurement of the propagation characteristic of a second receive signal in response to a second transmit signal from the first module;
demodulating the second receive signal to get a propagation characteristic measurement obtained by the first module.

19. The method of claim 18, wherein each of said propagation characteristic measurements comprises amplitude.

20. The method of claim 18, wherein each of said propagation characteristic measurements comprises phase, and wherein the method further comprises:
determining a clock offset between the first and second modules.

21. The method of claim 18, further comprising associating a tool orientation and position with each of said propagation characteristic measurements.
